(19) United States
(12) Patent Application Publication
(10) Pub. No.: US 2026/0103373 A1
(43) Pub. Date: Apr. 16, 2026

(54) SELECTABLE FILTRATION WATER DISPENSER

(71) Applicant: Quench USA, Inc., King Of Prussia, PA (US)

(72) Inventors: Theodore HERTZ, Lower Gwynedd, PA (US); Andrew Troy NUTTALL, Queen Creek, AZ (US); Todd Chamberlain PETERSON, Haverford, PA (US); Anthony IBARGUEN, Devon, PA (US)

(21) Appl. No.: 19/358,792

(22) Filed: Oct. 15, 2025

Related U.S. Application Data
(60) Provisional application No. 63/707,295, filed on Oct. 15, 2024.

(51) Int. Cl. B67D 1/07; B67D 1/00; B67D 1/12

(52) U.S. Cl. CPC B67D 1/07; B67D 1/0021; B67D 1/1202

(57) ABSTRACT

A water-dispensing device includes a source water intake, a spigot and a first common line downstream of the intake, a second common line downstream of the first common line and upstream of the spigot, and two or more branch lines, each of which is connected to the first and second common lines. At least one of the branch lines includes one or more enhancement filters. A flushing line downstream of the branch lines and upstream of the spigot is in selective fluid communication with the second common line via a flushing valve. A controller is configured to: commence a flushing operation by opening the flushing valve and actuating a flushing pump to draw water from the second common line into the flushing line, determine whether flushing of the second common line is completed, and upon such a determination, close the flushing valve and deactivate the flushing pump.

### CROSS-REFERENCE TO RELATED APPLICATIONS

This application claims priority to U.S. Provisional Patent Application No. 63/707,295, filed Oct. 15, 2024, entitled “Selectable Filtration Water Dispenser,” currently pending, the entire contents of which are incorporated by reference herein.

### BACKGROUND

Embodiments described herein relate generally to methods and apparatuses for the customized filtration and enhancement of drinking water, and more particularly, to such methods and apparatuses that prevent cross-contamination of differing water selections.

Water dispensers have recently become more sophisticated and can offer selectable options for filtering and/or enhancing the water. Such water dispensers may allow a user to select the addition of one or more enhancements or additives to the water, such as minerals, electrolytes, alkalinity, vitamins, fluoride, caffeine, flavors, combinations thereof, or the like. The water dispenser may include a series of filters through which the water may be routed in response to the selections made by the user. An example of such a water dispenser is shown and described in U.S. Pat. No. 12,084,338, the entire contents of which are incorporated by reference herein.

However, water dispensers utilizing these types of variably selectable filters may have a drawback in that the filters typically feed into a common downstream line that ultimately ends at a dispensing valve and/or spigot of the water dispenser. When a user customizes their water in a dispensing operation, some of the resulting treated water may remain in the line between the filters and the dispensing valve/spigot. If a user later selects a different customization, the treated water remaining from the previous operation may end up being undesirably mixed with the new selection.

It is desirable to provide a water dispenser that allows a user to dispense drinking water that has been filtered and/or enhanced with various customized additives based on the user's selection from a menu of such enhancements, but which prevents cross-contamination of water having differing additive characteristics.

### BRIEF SUMMARY

Briefly stated, one example embodiment comprises a water-dispensing device including a source water intake, a spigot arranged downstream from the source water intake, a first common line downstream of the source water intake, a second common line downstream of the first common line and upstream of and in selective fluid communication with the spigot, and two or more branch lines. Each of the two or more branch lines is connected to the first and second common lines. At least one of the branch lines includes one or more enhancement filters configured to provide additives to water traversing the respective branch line. A flushing line is arranged downstream of the two or more branch lines and upstream of the spigot. The flushing line is in selective fluid communication with the second common line via a flushing valve. The water-dispensing device further includes a flushing pump and a controller configured to: (i) commence a flushing operation by opening the flushing valve and actuating the flushing pump to draw water from the second common line into the flushing line, (ii) determine whether flushing of the second common line is completed, and (iii) upon determining flushing of the second common line is completed, close the flushing valve and deactivate the flushing pump.

In one aspect, the controller is further configured to: (iv) receive a water selection corresponding to one of the two or more branch lines, (v) determine at least one of: a) whether the received water selection matches a previous water selection, or b) whether a time elapsed since a previous dispensing operation exceeds a threshold, and (vi) perform the step of commencing the flushing operation in response to determining that the received water selection does not match the previous water selection or the time elapsed exceeds the threshold. In a further aspect, the controller is further configured to, after the step of closing the flushing valve and deactivating the flushing pump, commence a dispensing operation, including routing water through the one of the two or more branch lines corresponding to the received water selection.

In another aspect, the water-dispensing device further includes a conditioning element in the form of one of a chill tank or a water heater. In a further aspect, the second common line includes a conditioning line between the two or more branch lines and the conditioning element and a dispensing line between the conditioning element and the spigot.

In yet another aspect, the controller is further configured to: (iv) determine whether a dispensing operation for dispensing water through the spigot is completed, and (v) perform the step of commencing the flushing operation in response to determining the dispensing operation is completed.

In still another aspect, one of the two or more branch lines is a bypass branch line that does not include any enhancement filters.

In yet another aspect, the flushing line includes a check valve located downstream of the flushing valve.

In still another aspect, each of the two or more branch lines includes a branch valve configured to selectively place the respective branch valve in fluid communication with the first common line.

In yet another aspect, the additives include at least one of minerals, electrolytes, alkalinity, vitamins, fluoride, caffeine, flavors, or combinations thereof.

Another example embodiment comprises a method of operating a water-dispensing device having a source water intake, a spigot, a first common line downstream of the source water intake, a second common line downstream of the first common line and upstream of the spigot, two or more branch lines connected to the first and second common lines, at least one of the branch lines including one or more enhancement filters configured to provide additives to water traversing the respective branch line, a flushing line downstream of the two or more branch lines and upstream of the spigot, a flushing valve, a flushing pump, and a controller. The method includes performing a dispensing operation, by the controller in response to receiving a water selection corresponding to one of the two or more branch lines, by routing water from the source water intake through the first common line, the one of the two or more branch lines corresponding to the received water selection, the second common line, and the spigot, and performing, by the controller, a flushing operation including: (i) opening the flushing valve and actuating the flushing pump to draw water from the second common line into the flushing line, (ii) determining whether flushing of the second common line is completed, and (iii) upon determining flushing of the second common line is completed, closing the flushing valve and deactivating the flushing pump.

In one aspect, the method further includes, after receiving the water selection and prior to performing the dispensing operation, determining, by the controller, at least one of: a) whether the received water selection matches a previous water selection, or b) whether a time elapsed since a previous dispensing operation exceeds a threshold, and performing, by the controller, the flushing operation before the dispensing operation in response to determining that the received water selection does not match the previous water selection or the time elapsed exceeds the threshold.

In another aspect, the method further includes determining, by the controller, whether the dispensing operation is completed, and performing, by the controller, the flushing operation in response to determining that the dispensing operation is completed.

In yet another aspect, each of the two or more branch lines includes a branch valve, and the routing of water by the controller during the dispensing operation includes opening the branch valve of the one of the two or more branch lines corresponding to the received water selection.

Yet another example embodiment comprises a water-dispensing device including a source water intake, a spigot arranged downstream from the source water intake, a common line downstream of the source water intake, and two or more branch lines. Each of the two or more branch lines is connected at one end to the common line and at an opposite end to the spigot. At least one of the branch lines includes one or more enhancement filters configured to provide additives to water traversing the respective branch line. Each of the two or more branch lines has a branch valve configured to selectively place the respective branch valve in fluid communication with the common line. A controller is configured to (i) receive a water selection corresponding to one of the two or more branch lines, and (ii) in response to receiving the water selection, open the branch valve of the one of the two or more branch lines corresponding to the received water selection.

In one aspect, the water-dispensing device further includes a conditioning element located upstream of the spigot, the conditioning element being a chill tank. Each of the two or more branch lines includes a respective serpentine coil within the chill tank.

In another aspect, one of the two or more branch lines is a bypass branch line that does not include any enhancement filters.

In yet another aspect, the additives include at least one of minerals, electrolytes, alkalinity, vitamins, fluoride, caffeine, flavors, or combinations thereof.

### BRIEF DESCRIPTION OF THE SEVERAL VIEWS OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is a front perspective view of a water dispenser in accordance with an example embodiment of the present invention;

FIG. 2 is a schematic plumbing diagram of a portion of the water dispenser of FIG. 1;

FIG. 3 is a schematic plumbing diagram of an alternative example embodiment of a water dispenser;

FIG. 4 is a flow chart illustrating an example method performed by a controller for performing a flushing operation in response to a dispensing operation request; and

FIG. 5 is a flow chart illustrating an example method performed by a controller for performing a flushing operation following conclusion of a dispensing operation.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

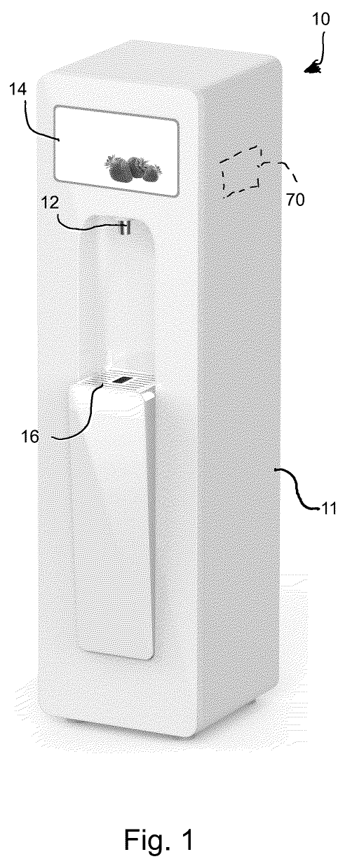

Referring to FIG. 1, there is shown a first example embodiment of a water dispenser 10 in accordance with the present invention. FIG. 1 depicts a free-standing water dispenser 10, but the water dispenser 10 may be of any conventional type in keeping within the spirit and scope of the invention, such as a countertop dispenser, a built-in dispenser (e.g., cabinet-mounted), a faucet dispenser, a coffee maker, or the like. The water dispenser 10 may include a housing 11 and may have a spigot 12 mounted in or on the housing 11 for dispensing water into a vessel (not shown), such as a cup, glass, bottle, or the like. The water dispenser 10 may further include a user interface 14, which can provide one or more dispensing actuators (not shown) such as buttons, touchscreen icons, touch-free sensors, or the like. A drip tray 16 may be positioned beneath the spigot 12. The drip tray 16 may support the vessel during a water dispensing operation, but is preferably also configured to provide a container to catch water accidentally spilled from the vessel or the spigot 12.

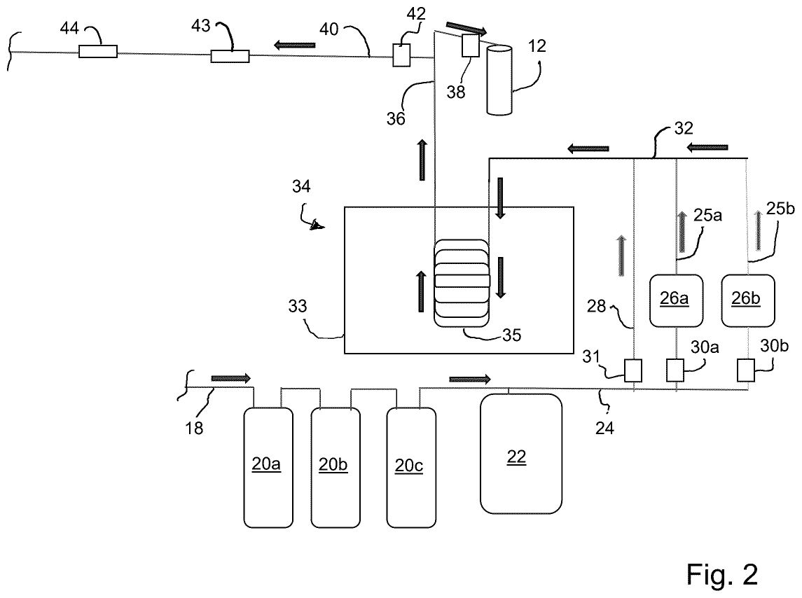

Referring to FIG. 2, the water dispenser 10 may include a water intake 18 that may be directly or indirectly connected to a water source (not shown), such as a building water supply, a container, or any other like source of water. One or more reductive filters 20 may be located downstream of the water intake 18. The reductive filters 20 may be quick change filters, sump filters, in-line filters, combinations thereof, or the like. For example, FIG. 2 depicts three reductive filters 20a, 20b, 20c placed in series with one another. The first filter 20a may be a sediment filter, the second filter 20b may be a carbon filter, and the third filter 20c may be a reverse osmosis filter. However, the number and order of filters 20 may differ, and other types of like filters 20 may be used in addition to, or in place of, those shown in FIG. 2. In this embodiment, water is required to proceed through the reductive filters 20 prior to conditioning, enhancement, and other operations downstream, although in some other embodiments, use of one or more of the reductive filters 20 on the water may also be made optional and be handled in in a manner similar to that described in more detail below with respect to the enhancement filters 26.

An optional bladder 22 may be utilized downstream of the reductive filters 20 to store water after filtering for on demand usage. This may be particularly useful when one or more of the reductive filters 20 utilizes reverse osmosis. The bladder 22 may build pressure as water is added and may provide about 35-45 psi of pressure when a dispensing operation is performed, although other pressures may be utilized as well. A booster pump (not shown) may be used in conjunction with the bladder 22 to control flow and provide ample pressure to run through enhancement filters 26 (as described in more detail below) while not causing a delay in dispensing. Although the bladder 22 is shown downstream of the reductive filters 20 in FIG. 2, in some embodiments, the bladder 22 may be positioned between certain reductive filters 20 (e.g., water may pass through one or more reductive filters 20 and be stored in the bladder 22 and passed through one or more additional reductive filters 20 in response to a water dispensing operation). In some embodiments, rather than a bladder 22, water passing through the reductive filter(s) 20 may be stored in a gravity tank (not shown), from which water may be pumped when dispensing. In still other embodiments, a bladder 22 or like structure may be omitted altogether.

A first conduit 24 may be arranged downstream of the filters 20 and/or the bladder 22. One or more enhancement filters 26 may be in selectable fluid communication with the first conduit 24. The filters 26 may be quick change filters, sump filters, in-line filters, combinations thereof, or the like. One or more of the enhancement filters 26 may be configured to provide additives to the water, such as minerals, electrolytes, alkalinity, vitamins, fluoride, caffeine, flavors, combinations thereof, or the like. In the example embodiment shown in FIG. 2, two enhancement filters 26a, 26b are connected to the first conduit 24 in respective parallel filter branches 25a, 25b. The first enhancement filter 26a may be an alkaline filter while the second enhancement filter 26b may be an electrolyte filter. However, the number and order of enhancement filters 26 may differ, and other types may be used in addition to, or in place of, those shown in FIG. 2. In addition, while each enhancement filter 26a, 26b in FIG. 2 is shown arranged in its own separate branch connected to the first conduit 24, a filter branch 25 may have more than one enhancement filter 26, when necessary. For example, where a user makes a specific selection for electrolytes and caffeine, a corresponding filter branch 25 may have one enhancement filter 26 for electrolytes and another for caffeine arranged in series with one another to add the selected constituents to the water. In still further embodiments, multiple enhancement filters 26 on a filter branch 25 may be arranged to allow for selective bypass of certain enhancement filters 26 within the filter branch 25 itself. In the previous example, if the user selects electrolytes but no caffeine, the water may proceed through the electrolyte filter but bypass the caffeine filter while remaining within the same branch. Other configurations can be utilized as well. FIG. 2 also shows a bypass branch 28 that may also be in selectable fluid communication with the first conduit 24. The bypass branch 28 may omit any enhancement filters 26 and allow the user to select unenhanced water.

Each filter branch 25 and the bypass branch 28 may be connected to the first conduit 24 by a respective electrically controlled valve 30a, 30b, 31 (e.g., a solenoid valve or the like). When operated, a valve 30 can open to allow water from the first conduit 24 to enter the respective filter branch 25 when the functionality of that respective enhancement filter or filters 26 is selected by the user, as explained in further detail below. When no enhancement filter 26 is selected, the valve 31 may open to allow the water to proceed through the bypass branch 28.

The filter branches 25 and the bypass branch 28 may connect to a common conditioning line 32, which may conduct the treated water to a conditioning element 34. For example, the conditioning element 34 may be a direct chill tank for cooling the filtered/enhanced water to a desirable temperature. In the example shown, the conditioning element 34 includes an ice bath 33 through which a serpentine coil 35 is submerged such that treated water is passed through the serpentine coil 35 for cooling by the ice bath 33. However, other types of chillers may be used instead. In some other embodiments, the conditioning element 34 is a water heater for supplying hot water. In still other embodiments, the water dispenser may have both a chiller and a water heater to be able to supply water at either cold or hot temperatures, and the water may be routed to the appropriate conditioning element via valves (not shown) depending on the user's selection. Although the conditioning element 34 is shown in FIG. 2 as being downstream of the enhancement filters 26, the conditioning element(s) 34 may be placed elsewhere in the system, such as upstream of the enhancement filters 26 so that water may be brought to the appropriate temperature prior to filtering, if desired. In still other embodiments, a conditioning element 34 may be omitted, such as where water is initially received by the dispenser 10 at the water intake 18 at an appropriate temperature or where ambient temperature water is to be dispensed.

The treated water may exit the conditioning element 34 and enter into a dispensing line 36. During a dispensing operation, a dispensing valve 38, which may be a solenoid valve or other type of electrically-actuated valve, may be opened to allow the treated water to exit the water dispenser 10 via the spigot 12. While only a single spigot 12 is shown in FIGS. 1 and 2, separate spigots may be provided for dispensing cold and hot water, or for different types of water, as desired.

To address the issue that, for example, alkaline treated water may remain in the conditioning line 32, conditioning element 34, and/or the dispensing line 36 after a dispensing operation of alkaline water has been completed, a flushing line 40 may branch off of the dispensing line 36 upstream of the dispensing valve 38 to allow water remaining in the aforementioned system plumbing to be removed prior to or concurrent with a new dispensing operation, which may be for differently treated water than in the previous dispensing operation. The flushing line 40 may be connected to a drain, sewage line, or the like (not shown), and utilize a flushing valve 42, which may be a solenoid valve or other type of electrically-actuated valve, to selectively allow water to proceed into the flushing line 40. A check valve 43 may be placed in the flushing line 40 downstream of the flushing valve 42 to prevent any reverse flow. A flushing pump 44 may be used to draw water from the conditioning line 32, conditioning element 34, and/or the dispensing line 36 into the flushing line 40. While the flushing pump 44 is shown in FIG. 2 located downstream of the check valve 43, other configurations may be utilized as well.

Referring again to FIG. 1, valves (e.g., such as valves 30, 31, 38, and 42 in FIG. 2 and/or one or more other valves (not shown) within the system) may be operated by at least one controller 70, which may by a microcontroller unit (MCU), a central processing unit (CPU), a microprocessor, an application specific controller (ASIC), a programmable logic array (PLA), combinations thereof, or the like. The controller 70 may include or be coupled to a memory (not shown) that may store code or software for carrying out processes described herein and/or carrying out other operations of the water dispenser 10 and may store any captured data for later transfer to remote or external devices. It should be further appreciated that the controller 70 is shown schematically in this example as a single component, but may include a plurality of individual devices, with control functions divided among the individual devices.

The controller 70 may be in communication with the user interface 14, although in other embodiments, the controller 70 may be in wired communication (e.g., via USB, Ethernet, IEEE 1394, or the like) or wireless communication (e.g., via WI-FI, BLUETOOTH, ZIGBEE, Z-WAVE, 3G, 4G, or 5G cellular, infrared, or the like) with an external device (not shown), such as a smartphone, laptop, tablet, desktop, or the like. Preferably, the user is able to make selections for filtering and/or enhancing dispensed water via the user interface 14 (or via an external device in some embodiments), which may be received by the controller 70 and used to actuate appropriate valves 30, 31 and other components to match the user selection.

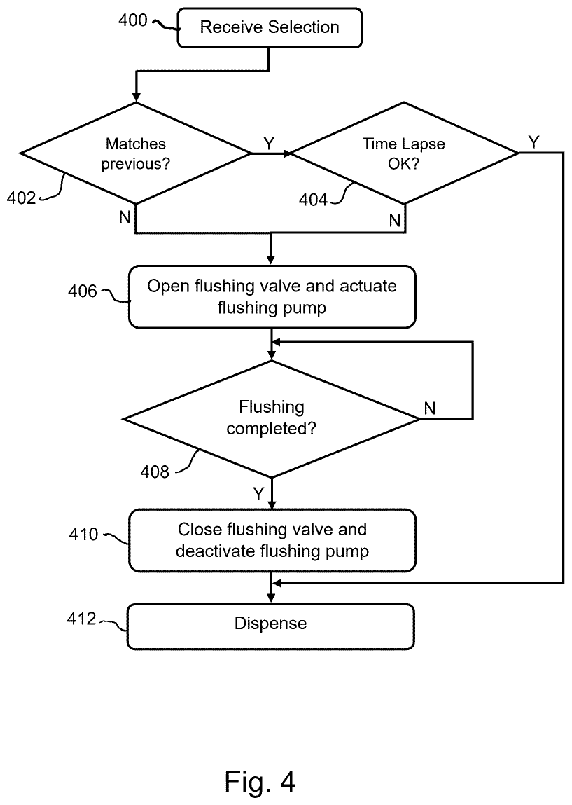

FIG. 4 shows an example of a method that may be performed by the controller 70 for flushing the conditioning line 32, conditioning element 34, and/or the dispensing line 36. In this example, the flushing potentially occurs in response to a requested dispense operation. At step 400, the controller 70 may receive a water selection from a user, such as via the user interface 14, a remote device (e.g., smartphone or the like), or the like. The controller 70 may use the received selection to configure the valves (e.g., valves 30, 31) to allow the water to flow through enhancement filter(s) 26 that correspond to the received selection or bypass the enhancement filters 26, as needed based on the selection.

At step 402, the controller 70 may compare the received selection to the previously received selection, which may be stored in memory or the like. If the current and previous selections match one another, the need for a flushing operation may be lessened in that there is not a cross-contamination concern with water remaining from the previous dispense operation. However, the remaining water may no longer be at an optimal temperature for dispensing, or otherwise may have been stagnant for too long and is therefore otherwise undesirable for dispensing. Thus, at step 404, if the currently received selection has been determined at step 402 to match the prior selection, the controller 70 may also determine how much time has elapsed since the previous dispensing operation. This may be done using an internal timer that resets every time a dispensing operation is completed, a log may be kept of all dispense operations against which the current time may be compared, or the like. A predetermined limit may be set at the controller 70 for determining how long is too long between dispense operations to forego a flushing operation. If the controller 70 determines that the elapsed time is acceptable for foregoing a flushing operation, the controller 70 may then proceed directly to step 412 and dispense the currently selected beverage according to the necessary filtering path.

While the example in FIG. 4 shows the comparison of current and previous selections occurring first and the timing consideration being performed only if a match is found, the steps may be performed in a reverse order. That is, the controller 70 may first determine whether the time elapsed since the last dispensing operation is still below the predetermined flushing threshold, and if so, the controller 70 may thereafter determine whether the current selection matches the previous selection. It is also conceivable in certain embodiments that steps 402 and 404 may be performed independently from one another, i.e., each question may be resolved by the controller 70 irrespective of the answer to the other. In such circumstances, steps 402 and 404 may be performed generally simultaneously, although sequential determinations are also possible despite the outcomes of each not influencing the other. In all these examples, the controller 70 may only perform a dispensing operation without flushing if both conditions are met. Otherwise, the flushing operation will commence prior to dispensing step 412, as will be explained in further detail below. It is further contemplated that one of step 402 or 404 may be omitted. In still further embodiments, other conditions not shown in FIG. 4 may also be taken into account by the controller 70 to determine whether a flushing operation should be performed. In yet additional embodiments, it is possible that a flushing operation may be performed automatically in response to receipt of a water selection irrespective of whether the prior selection matches or a certain amount of time has elapsed, such that steps 402 and 404 and any other gating steps may be omitted.

If either the previous selection does not match the current selection at step 402, or the time elapsed since the previous dispensing operation exceeds a predetermined threshold, then the controller 70 may proceed to perform a flushing operation. At step 406, the controller 70 may open the flushing valve 42 and actuate the flushing pump 44. The flushing pump 44 may draw water in the filter branch(es) 25 and/or the bypass branch 28, the conditioning element 34, and the dispensing line 36 into the flushing line 40 through the flushing valve 42. At step 408, the controller 70 may determine whether the flushing operation is completed. For example, a predetermined time for moving water may be set (e.g., the controller 70 may be programmed to run the flushing pump 44 for ten seconds to clear the subject fluid path), one or more sensors (not shown) may communicate with the controller 70 (e.g., sensors may be placed upstream of the flushing valve 42 to detect whether water is still present, flow sensors may be used to detect that a certain amount of water has been moved, or the like), combinations thereof, or the like. When the controller 70 ultimately determines that the flushing has completed, at step 410, the controller 70 may close the flushing valve 42 and deactivate the flushing pump 44. At step 412, the controller 70 may initiate dispensing, such as by opening the dispensing valve 38 with the appropriate valves 30, 31 configured.

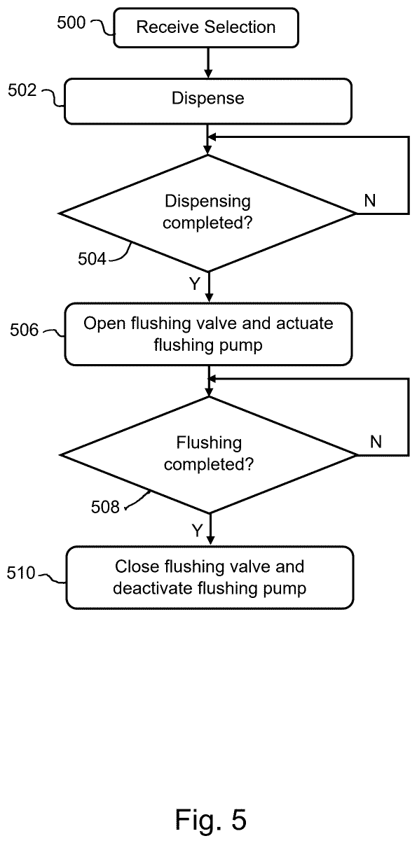

In some embodiments, the controller 70 may be programmed to perform a flushing operation following a dispensing operation to ensure that the common fluid path downstream of the enhancement filters 26 is empty for the next dispensing operation. An example of such a method is shown in FIG. 5. At step 500, the controller 70 may receive a water selection from a user, such as via the user interface 14, a remote device (e.g., smartphone or the like), or the like. The controller 70 may use the received selection to configure the valves (e.g., valves 30, 31) to allow the water to flow through enhancement filter(s) 26 that correspond to the received selection or bypass the enhancement filters 26, as needed. At step 502, the controller 70 commences the dispense operation, such as by opening the dispensing valve 38 with the appropriate valves 30, 31 configured.

At step 504, the controller 70 may determine whether the dispensing operation is completed. For example, a predetermined time for dispensing water may be set (e.g., the controller 70 may be programmed to keep the dispensing valve 38 open for a certain amount of time depending on the volume of water expected to be dispensed), one or more sensors (not shown) may communicate with the controller 70 (e.g., flow sensors may be used to detect that a certain amount of water has been dispensed, or the like), combinations thereof, or the like. When the controller 70 ultimately determines that the dispensing has completed, at step 506, the controller 70 may close the dispensing valve 38 and initiate flushing by opening the flushing valve 42 and actuating the flushing pump 44. The flushing pump 44 may draw any water remaining in the filter branch(es) 25 and/or the bypass branch 28, the conditioning element 34, and the dispensing line 36 from the completed dispensing operation into the flushing line 40 through the flushing valve 42. At step 508, the controller 70 may determine whether the flushing operation is completed, such as by the methods described above for step 408 in FIG. 4. When the controller 70 ultimately determines that the flushing has completed, at step 510, the controller 70 may close the flushing valve 42 and deactivate the flushing pump 44. The controller 70 may now await the next selection.

A controller 70 may be programmed to perform both methods shown in FIGS. 4 and 5, and the user may have the option to select, as a device preference, which flushing method may be used. In still other embodiments, the controller 70 may be programmed to perform a flushing operation in response to a predetermined period of inactivity of the water dispenser 10. This may be used as the sole flushing method or may be utilized in conjunction with one or more of the methods described above.

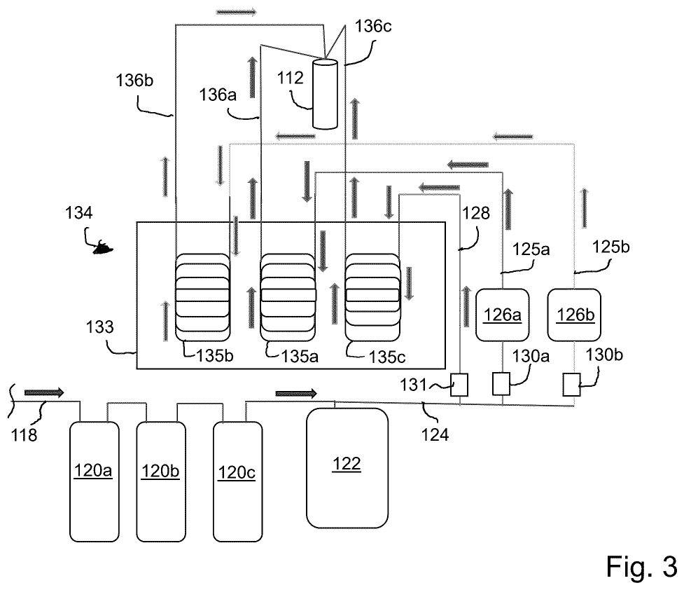

FIG. 3 shows a second example embodiment of a plumbing arrangement for a water dispenser. Like numerals have been used for like elements, except the 100 series numerals have been used for the example embodiment shown in FIG. 3. Accordingly, a complete description of this embodiment has been omitted, with mainly the differences being described.

The embodiment in FIG. 3 solves the cross-contamination problem in a different manner. Once water is diverted from the first conduit 124 to one of the filter branches 125, or the bypass branch 128, in this embodiment, the water conveys in its own separate and independent line until reaching the spigot 112. For example, the alkaline filter 126a and its corresponding branch 125a connect directly to a first serpentine coil 135a within the ice bath 133 of the chill tank 134. The first serpentine coil 135a then feeds into a first dispensing line 136a in fluid communication with the spigot 112. Similarly, the electrolyte filter 126b and its corresponding branch 125b separately connect directly to a second serpentine coil 135b within the ice bath 133 of the chill tank 134. The second serpentine coil 135b then feeds into a second dispensing line 136b in fluid communication with the spigot 112. The bypass branch 128 similarly connects directly to its own third serpentine coil 135c, which feeds into a third dispensing line 136c in fluid communication with the spigot 112. Any number of separate filter branches 125 may connect to a respective conditioning element 134 en route to the spigot 112, thereby preventing cross-contamination.

Again, although each filter branch 125 in FIG. 3 is shown as having only a single enhancement filter 126, multiple enhancement filters 126 may be arranged in series on a single filter branch 125. In still further embodiments, multiple enhancement filters 126 on a filter branch 125 may be arranged to allow for selective bypass of certain enhancement filters 126 within the filter branch 125 itself.

In certain other embodiments, instead of having a common conditioning element 134 with separate coils 135 disposed therein, each filter branch 125 and the bypass branch 128 may connect to their own respective conditioning elements 134. In embodiments where the conditioning element 134 is located upstream of the filter branches 125 and the bypass branch 128, each may simply connect to its own dispensing line 136 and proceed to the spigot 112 following filtering or bypass operations.

Although not shown in FIG. 3, one or more dispensing valves may be utilized to control flow through the spigot 112. In addition, there may be a common flushing line or individual flushing lines (including any necessary components such as valves, pumps, or the like) for purging one or more of the lines feeding the spigot 112, such as to remove stagnant water, water that no longer matches the desired temperature, or the like. The controller (not shown) in a dispenser employing the configuration shown in FIG. 3 may utilize automatic flushing or flushing operations similar to those described above, when appropriate.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

We claim:

1. A water-dispensing device comprising:
a source water intake;
a spigot arranged downstream from the source water intake;
a first common line downstream of the source water intake;
a second common line downstream of the first common line and upstream of and in selective fluid communication with the spigot;
two or more branch lines, each of the two or more branch lines being connected to the first and second common lines, at least one of the branch lines including one or more enhancement filters configured to provide additives to water traversing the respective branch line;
a flushing line arranged downstream of the two or more branch lines and upstream of the spigot, the flushing line being in selective fluid communication with the second common line via a flushing valve;
a flushing pump; and
a controller configured to:
(i) commence a flushing operation by opening the flushing valve and actuating the flushing pump to draw water from the second common line into the flushing line,
(ii) determine whether flushing of the second common line is completed, and
(iii) upon determining flushing of the second common line is completed, close the flushing valve and deactivate the flushing pump.

2. The water-dispensing device of claim 1, wherein the controller is further configured to:
(iv) receive a water selection corresponding to one of the two or more branch lines,
(v) determine at least one of:
a) whether the received water selection matches a previous water selection, or
b) whether a time elapsed since a previous dispensing operation exceeds a threshold, and
(vi) perform the step of commencing the flushing operation in response to determining that the received water selection does not match the previous water selection or the time elapsed exceeds the threshold.

3. The water-dispensing device of claim 2, wherein the controller is further configured to, after the step of closing the flushing valve and deactivating the flushing pump, commence a dispensing operation, including routing water through the one of the two or more branch lines corresponding to the received water selection.

4. The water-dispensing device of claim 1, further comprising a conditioning element in the form of one of a chill tank or a water heater.

5. The water-dispensing device of claim 4, wherein the second common line includes a conditioning line between the two or more branch lines and the conditioning element and a dispensing line between the conditioning element and the spigot.

6. The water-dispensing device of claim 1, wherein the controller is further configured to:
(iv) determine whether a dispensing operation for dispensing water through the spigot is completed, and
(v) perform the step of commencing the flushing operation in response to determining the dispensing operation is completed.

7. The water-dispensing device of claim 1, wherein one of the two or more branch lines is a bypass branch line that does not include any enhancement filters.

8. The water-dispensing device of claim 1, wherein the flushing line includes a check valve located downstream of the flushing valve.

9. The water-dispensing device of claim 1, wherein each of the two or more branch lines includes a branch valve configured to selectively place the respective branch valve in fluid communication with the first common line.

10. The water-dispensing device of claim 1, wherein the additives include at least one of minerals, electrolytes, alkalinity, vitamins, fluoride, caffeine, flavors, or combinations thereof.

11. A method of operating a water-dispensing device having a source water intake, a spigot, a first common line downstream of the source water intake, a second common line downstream of the first common line and upstream of the spigot, two or more branch lines connected to the first and second common lines, at least one of the branch lines including one or more enhancement filters configured to provide additives to water traversing the respective branch line, a flushing line downstream of the two or more branch lines and upstream of the spigot, a flushing valve, a flushing pump, and a controller, the method comprising:
performing a dispensing operation, by the controller in response to receiving a water selection corresponding to one of the two or more branch lines, by routing water from the source water intake through the first common line, the one of the two or more branch lines corresponding to the received water selection, the second common line, and the spigot; and
performing, by the controller, a flushing operation including:
(i) opening the flushing valve and actuating the flushing pump to draw water from the second common line into the flushing line,
(ii) determining whether flushing of the second common line is completed, and
(iii) upon determining flushing of the second common line is completed, closing the flushing valve and deactivating the flushing pump.

12. The method of claim 11, further comprising:
after receiving the water selection and prior to performing the dispensing operation, determining, by the controller, at least one of:
a) whether the received water selection matches a previous water selection, or
b) whether a time elapsed since a previous dispensing operation exceeds a threshold; and
performing, by the controller, the flushing operation before the dispensing operation in response to determining that the received water selection does not match the previous water selection or the time elapsed exceeds the threshold.

13. The method of claim 11, further comprising:
determining, by the controller, whether the dispensing operation is completed; and
performing, by the controller, the flushing operation in response to determining that the dispensing operation is completed.

14. The method of claim 11, wherein each of the two or more branch lines includes a branch valve, and wherein the routing of water by the controller during the dispensing operation includes opening the branch valve of the one of the two or more branch lines corresponding to the received water selection.

15. A water-dispensing device comprising:
a source water intake;
a spigot arranged downstream from the source water intake;
a common line downstream of the source water intake;
two or more branch lines, each of the two or more branch lines being connected at one end to the common line and at an opposite end to the spigot, at least one of the branch lines including one or more enhancement filters configured to provide additives to water traversing the respective branch line, each of the two or more branch lines having a branch valve configured to selectively place the respective branch valve in fluid communication with the common line; and
a controller configured to:
(i) receive a water selection corresponding to one of the two or more branch lines, and
(ii) in response to receiving the water selection, open the branch valve of the one of the two or more branch lines corresponding to the received water selection.

16. The water-dispensing device of claim 15, further comprising a conditioning element located upstream of the spigot, the conditioning element being a chill tank, and wherein each of the two or more branch lines includes a respective serpentine coil within the chill tank.

17. The water-dispensing device of claim 15, wherein one of the two or more branch lines is a bypass branch line that does not include any enhancement filters.

18. The water-dispensing device of claim 15, wherein the additives include at least one of minerals, electrolytes, alkalinity, vitamins, fluoride, caffeine, flavors, or combinations thereof.
